(19) United States
(12) Patent Application Publication
(10) Pub. No.: US 2010/0110899 A1
(43) Pub. Date: May 6, 2010

(54) STRESSING A NETWORK DEVICE

(76) Inventors: Craig A. Vanzante, Roseville, CA (US); Robert R. Brodeur, Auburn, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/262,490

(22) Filed: Oct. 31, 2008

(51) Int. Cl. H04L 12/26

(52) U.S. Cl. 370/242

(57) ABSTRACT

A method of stressing a network device includes sending an echo request having a payload to the network device. The payload is configured to stress the network device. The method also includes determining whether the network device is healthy despite receiving the payload.

### BACKGROUND

The integrity, security, and stability of communication networks can be verified with stress testing the network or its component devices. Stress testing can be used to determine if the network and its components are working correctly or within parameters. Without testing and then fixing problems and failures, networks and their components can be subject to failures in the field or attacks, whether passive or active. If a device does fail in the field, there can be a significant lag time between its failure and the report of its failure, and even more lag time until the problem is fixed. During this lag time, the network can be operating incorrectly or not operating at all.

Often, stress testing involves subjecting the network to heavy traffic loads or to particular messages that are often out of typical ranges for the network. In one example, a network can be stress tested by subjecting it to heavy data loads to determine which parts of the network are operating within parameters or to determine which parts of the network will fail under the test. A device can be subject to number of types of network stress. One category of these types of stress is often referred to as stress and margin, where different features or aspects of the device are tested and the performance of the device or network is analyzed. For example, the device can be subjected to a high current, low current, high temperature, low temperature, out of range throughput, high load, and the like, and its performance analyzed.

In addition to stress testing an operational communications network, individual components are often tested in simulation during manufacturing and prior to implementation. This sort of pre-implementation stress testing is useful because the device can be subjected to a test that will likely cause the device to fail without fear of affecting an actual network.

Various types of stress tests are known. Testers may develop proprietary techniques for testing certain equipment. Such techniques need not be commercially available for purchase and are directed to the certain equipment. The cost for develop of these techniques is typically very high and can often be very difficult to maintain. Another option is to purchase commercially available test equipment and associated software. These commercially available techniques can be platform specific, complicated to use, and include features far beyond what is needed for stress and margin purposes.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a schematic view of an example environment of the disclosure.

FIG. 2 is a schematic view of an example of the disclosure.

FIG. 3A is a schematic view of a version of the example of FIG. 2.

FIG. 3B is a schematic view of another version of the example of FIG. 2.

FIG. 4 is schematic view of a feature of an example of the disclosure.

FIG. 5 is a block diagram of another feature of an example of the disclosure.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

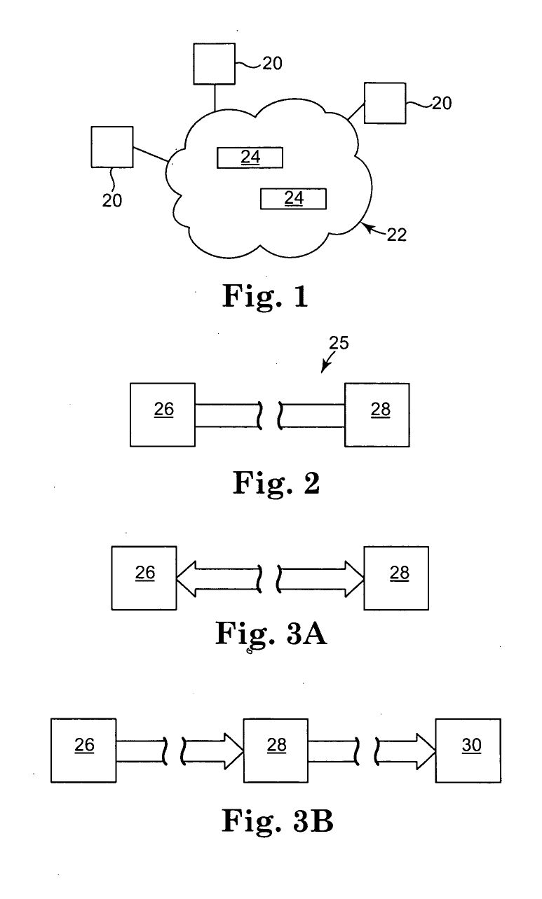

FIG. 1 illustrates an example environment of elements of this disclosure. FIG. 1 illustrates a plurality of devices 20 coupled together over a network 22. The devices can include servers, computers, workstations, smart phones, or any other device that can work on or with a network. The devices are communicatively coupled together in that one device can send a message to another. Devices 20 are shown as endpoints where they can generate or receive data transmitted on the network 22. The network 22 can also include devices 24 that help pass data through the network, such as routers, switches, repeaters, and other devices. Devices 20 and 24 collectively can be considered to be network devices. The networks as set forth in this disclosure can be large like the Internet or as small as two network devices communicatively coupled together.

FIG. 2 is an example system 25 including two network devices 26, 28 communicatively coupled to each other for stress-testing. In the example, network device 26 is tester device that is performing a stress test on network device 28, or the test subject device. In the example, the tester device 26 is configured to send a stressful message to the test subject device 28. The stressful message includes a stressful data pattern or a payload configured to stress one or more features of the test subject to determine if the test subject can withstand the effects of the message. A stressful data pattern includes known sequences of bytes that can adversely affect certain features of the test subject device 28 and are described in more detail below.

FIG. 3A illustrates an example implementation of the system 25. The implementation includes the tester device 26 in two way communication with the test subject device 28, such as over a wide area network or in a laboratory. The tester device 26 sends a stressful message to the test subject device 28. The tester device or an operator of the tester device then determines whether the test subject device 28 is healthy.

In one example, the test subject device 28 receives the stressful message and returns a response message to the tester device 26. The message can indicate that the test subject device 28 is healthy or that the device 28 has suffered some kind of failure. A set of statistics or measurements can be included in the test message to indicate the operation of certain features of the test subject device 28. An operator of the tester device 26 can then analyze or process the statistics or measurements to determine whether the device is healthy, or operating within selected parameters, despite receiving the stressful message.

In another example, the test subject device 28 will fail. In this case, there may be no set of statistics or measurements returned to the tester device 26. In order to account for this, the tester device can be set to wait for a selected time after sending the stressful message. If no response is received within the selected time, the tester device will indicate that the device has failed as a response to the stressful message.

In one example, the test subject device 28 is configured to return a message to the tester device 26. The test subject device can be configured to include a version of a network agent that can receive, decode, and respond to the stressful message. The response can include a set of statistics that can be decoded, processed, or both, by the test subject device 26 or another processor device used in stress testing the test subject device 28.

FIG. 3B illustrates another example implementation of the system 25. This implementation includes the tester device 26, the test subject device 28, and also a second tester device. In this implementation, the tester device 26 sends a stressful message to the second tester device 30 through the test subject device 28. In one example, the information regarding the message pass through—such as whether the message even passes through the test subject device 28, how long it takes the message to pass through, or what condition the message is in when it arrives at the second tester device 30—can be used to determine whether the test subject device is healthy despite the stressful message. Other implementations of the system 25 are contemplated.

The message sent from the tester device 26 can be a typical network tool such as a ping. This tool works by sending an Internet Control Message Protocol (ICMP) packet or packets to the test subject device, or the target host. ICMP messages are typically constructed at the Internet Protocol (IP) layer, or sometimes referred to as the Network/Internet layer. In the TCP/IP model, the IP layer exists between the Data Link layer (layer 2) and the Transport layer (layer 4). Many common network utilities are based on ICMP messages, such as ping.

Ping works by sending an “echo request” packet from the tester device to the target host and then waiting for an “echo response” reply. It is contemplated that other tools that serve the echo request/echo reply function can be developed, so the claims are not necessarily limited to the ping utility or even to ICMP. This example is described with reference to an ICMP echo request and ICMP echo reply, although this disclosure is not so limited.

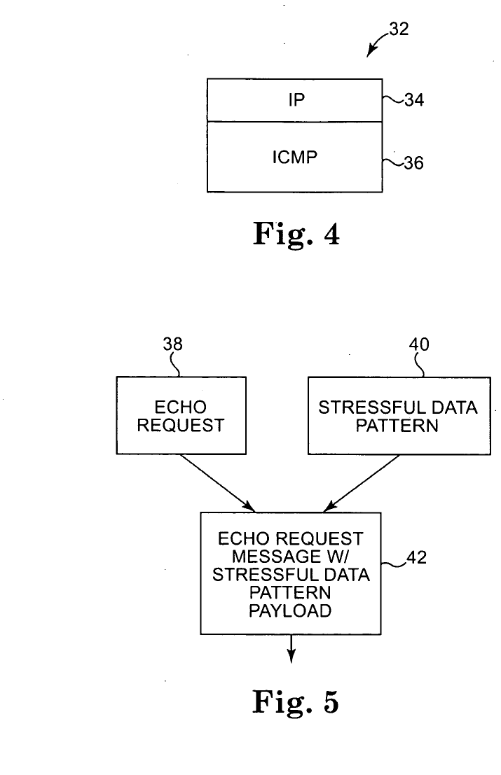

FIG. 4 illustrates a typical ICMP packet or message 32. The message includes an IP header 34 and an ICMP payload 36. The message also includes information such as message type, code, checksum, identifier, sequence number and data.

The echo request message in ICMP includes data that is expected to be returned in an ICMP echo reply. In an ICMP echo request, the type is set to 8 and the code is set to 0. The identifier and sequence number can be used to match the reply with the request. An ICMP echo reply is generated by the target host in response to the echo request. The type and code of an echo reply are both set to 0. The identifier and sequence number are used to determine which echo requests are associated with which echo replies, which is useful when multiple pings are sent on the network.

In operation, if the tester device 26 does not receive a reply at all the message will exit with a code that indicates this. If a deadline for receiving a reply and a packet count is specified, the code can indicate if less than the packet count is received by the deadline. A second code can indicate if another error has occurred. If the device is healthy, the message will exit with a third code. Other examples are contemplated.

The use of ping as a “network diagnostic tool” is known. This network diagnostic function, however, has been limited to determining whether a host target is reachable across an IP network and includes measuring packet loss and estimating round trip time. Ping can be used to check for broken hardware and network stability. In the present examples, message is used to actually affect the network devices and to stress test them, which differs from previous application of ping.

The message includes a payload 36 that includes a stressful data pattern or is otherwise configured to stress the test subject device 28. A stressful data pattern includes a sequence of bytes of data that is known to at times cause an adverse affect of certain features of a network device. Stressful data patterns, or sometimes referred to as suspicious data patterns, are known or can be developed in order to take the network device to the limits of its parameters. A particular sequence of data is known or can be developed to try to cause a particular network device to fail.

Stressful data patterns can be general and can affect many different devices, and other stressful data patterns can be specific and can affect only a selected make or model network device. Stressful data patterns can adversely affect several features of the network device or they can adversely affect only a single known feature of the network device. Accordingly, a tester can cache several different stressful data patterns, or even several sets of different stressful data patterns, for use in testing.

An example of one stressful data pattern suitable for stress testing is the following 160 byte sequence represented in hexadecimal format:

$$0000000000 ffffff 0000000000 fffff$$

$$0000000000 ffffff 0000000000 ffffff$$

$$0000000000 ffffff 0000000000 ffffff$$

$$0000000000 ffffff 0000000000 ffffff$$

$$0000000000 ffffff 0000000000 ffffff$$

$$00000000000000000000000000000000$$

$$00000000000000000000000000000000$$

$$00000000000000000000000000000000$$

$$00000000000000000000000000000000$$

$$00000000000000000000000000000000$$

FIG. 5 illustrates an example of a method of creating stressful messages, for example out of stressful data patterns. The method includes providing a system to generate a version of ping, or echo request, message 38. The method also includes providing a stressful data pattern that can selectively stress a target network device 40. The stressful data pattern is included as a payload into the message 42, which then can be used to stress test a selected feature or features of a selected network device or devices.

Systems for generating versions of ping or echo request messages are well known and are ubiquitous. For example, many operating systems—for example general purpose computer operating systems such as LINUX, UNIX, WINDOWS, and others—include ping utilities. Also, ping utilities are available from open source software developers. The ping or ping utility can be used to generate a certain number of packets with a selected data pattern and size to a selected network device. In an example, a message directed at a network device at a network address of 10.0.8.1 can be written in a LINUX version of ping as:

ping-c 10-p0-s 100 10.0.8.1

which will send 10 packets of a payload of zeros where each packet has a size of 100 bytes to the network device at address 10.0.8.1.

The stressful data pattern can include its own number of packet count and sequence of bits of data. Otherwise, the packet count can be selected and the payload and size of packets can be determined.

Combining the stressful data pattern as a payload into the ping packet can be performed in many different ways. In one basic example, the tester can write each message. In other examples, the process can be scripted. Several different stressful data patterns can be included in different messages, or in one message, to create a suite of test messages. The suite of test messages can be configured to selectively stress different features of the network device, to selectively stress several different network devices, or to selectively stress different features in each of several different network devices.

The examples of this disclosure are particularly advantageous for several reasons. One of these reasons is that it provides a straightforward implementation because it can work without specialized hardware or software. The tests can be customized for a particular network device or a set of network device, and the tests and test equipment can be used on multiple platforms.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of stressing a network device, comprising:
sending an echo request having a payload to the network device, wherein the payload is configured to stress the network device; and
determining whether the network device is healthy despite receiving the payload.

2. The method of claim 1 wherein the echo request is a ping packet.

3. The method of claim 2 wherein the sending of the echo request includes using the Internet Control Message Protocol to send the echo request.

4. The method of claim 2 wherein sending the echo request includes sending a single packet.

5. The method of claim 1 wherein the sending the echo request includes sending the echo request with a testing device and the determining includes receiving a response from the network device.

6. The method of claim 5 wherein the receiving the response includes receiving the response with the testing device.

7. The method of claim 5 wherein receiving the response from the network device includes receiving an echo response from the network device.

8. The method of claim 1 wherein the information as to whether the network device is healthy includes determining whether the network device has failed.

9. The method of claim 8 wherein the determining includes waiting for a response and receiving no message from the network device when the payload has caused the network device to fail.

10. A method of creating a stressful message for a network device, comprising:
providing a system to generate a version of a ping packet;
providing at least one stressful data pattern configured to selectively stress the network device; and
combining the stressful data pattern as a payload into the version of the ping packet.

11. The method of claim 10 wherein the system to generate a version of the ping packet includes a ping utility.

12. The method of claim 11 wherein the ping utility is included in a general purpose computer operating system.

13. The method of claim 10 wherein providing the at least one stressful data pattern includes providing a plurality of different stressful data patterns to create a suite of stressful messages.

14. The method of claim 13 wherein the suite of stressful data patterns are configured to selectively stress different features of the network device, to selectively stress a plurality of different network devices, or to selectively stress different features in each of a plurality of different network devices.

15. The method of claim 10 wherein the combining the stressful data pattern as the payload includes scripting the stressful data pattern into the payload.

16. The method of claim 10 wherein the stressful data pattern is unique to the network device.

17. A system for stress-testing, comprising:
a test subject device;
a tester device communicatively coupled to the test subject device; and
a ping message having a payload, the payload including a stressful data pattern configured to selectively stress the test subject device;
wherein the tester device is configured to send the ping message to the test subject device.

18. The system of claim 17 and further comprising remote tester device, wherein the remote tester device is configured to receive a response from the test subject device.

19. The system of claim 17 wherein the test subject device is a network switch.

20. The system of claim 17 wherein the test subject device is communicatively coupled to the tester device over a computer network.
